(19) United States
(12) Patent Application Publication
(10) Pub. No.: US 2013/0153794 A1
(43) Pub. Date: Jun. 20, 2013

(54) EXTREME ULTRAVIOLET LIGHT GENERATION APPARATUS

(71) Applicant: Osamu Wakabayashi, Hiratsuka-shi (JP)

(72) Inventor: Osamu Wakabayashi, Hiratsuka-shi (JP)

(73) Assignee: GIGAPHOTON INC., Oyama-shi, Tochigi (JP)

(21) Appl. No.: 13/817,813

(22) PCT Filed: Nov. 10, 2011
(86) PCT No.: PCT/IB2011/002657

§ 371 Date: Feb. 19, 2013

(30) Foreign Application Priority Data
Nov. 25, 2010 (JP) 2010-262842

(51) Int. Cl. H05G 2/00

(52) U.S. Cl. CPC H05G 2/003
USPC 250/504 R

(57) ABSTRACT

An apparatus uses first and second laser beams from a laser apparatus to generate extreme ultraviolet light. The apparatus may include a chamber provided with at least one inlet through which at least one of first and second laser beams outputted from the laser apparatus travels into the chamber. A beam shaping unit is provided on a beam path of the first laser beam for transforming the first laser beam into a hollow laser beam. A first focusing optical element is provided downstream of the beam shaping unit for focusing the hollow laser beam in a first location inside the chamber.

### CROSS-REFERENCE TO RELATED APPLICATIONS

The application claims priority of Japanese Patent Application No. 2010-262842 filed Nov. 25, 2010, the entire contents of which are hereby incorporated by reference.

### BACKGROUND

1. Technical Field

This disclosure relates to an apparatus for generating extreme ultraviolet light.

2. Related Art

Photolithog raphy processes have been continuously improving for semiconductor device fabrication. Extreme ultraviolet (EUV) light at a wavelength of approximately 13 nm is useful in the photolithography processes to form extremely small features (e.g., 32 nm or less features) in, for example, semiconductor wafers.

Three types of system for generating EUV light have been well known. The systems include an LPP (Laser Produced Plasma) type system in which plasma generated by irradiating a target material with a laser beam is used, a DPP (Discharge Produced Plasma) type system in which plasma generated by electric discharge is used, and an SR (Synchrotron Radiation) type system in which orbital radiation is used.

### SUMMARY

An apparatus according one aspect of this disclosure may be used in combination with a laser apparatus for generating extreme ultraviolet light by using first and second laser beams from the laser apparatus. The apparatus may include: a chamber provided with at least one inlet through which at least one of the first and second laser beams from the laser apparatus travels into the chamber; a beam shaping unit, provided on a beam path of the first laser beam, for transforming the first laser beam into a hollow laser beam; and a first focusing optical element, provided downstream of the beam shaping unit, for focusing the hollow laser beam on a first location inside the chamber.

### BRIEF DESCRIPTION OF THE DRAWINGS

FIG. 1 schematically shows an EUV light generation apparatus according to a first embodiment of this disclosure.

FIG. 2 shows an example of a beam shaping unit according to the first embodiment.

FIG. 3 is a sectional view of the beam shaping unit shown in FIG. 2.

FIG. 4 shows an example of a focusing optical system including an off-axis paraboloidal mirror and a focusing lens according to the first embodiment.

FIG. 5 schematically shows an EUV light generation apparatus according to a second embodiment of this disclosure.

FIG. 6 schematically shows a beam shaping unit, a flat mirror, and an off-axis paraboloidal mirror shown in FIG. 5.

FIG. 7 schematically shows an EUV light generation apparatus according to a third embodiment of this disclosure.

FIG. 8 shows an example of a rotationally symmetric off-axis paraboloidal mirror and a focusing lens according to the third embodiment.

FIG. 9 schematically shows an EUV light generation apparatus according to a fourth embodiment of this disclosure.

FIG. 10 schematically shows a window shown in FIG. 9.

FIG. 11 shows an example of the relationship among the window, a hollow main pulse laser beam, and a pre-pulse laser beam.

FIG. 12 shows a beam shaping unit according to a modification.

FIG. 13 is a sectional view of the beam shaping unit shown in FIG. 12.

FIG. 14 shows another beam shaping unit according to the modification.

FIG. 15 is a sectional view of the beam shaping unit shown in FIG. 14.

FIG. 16 shows yet another beam shaping unit according to the modification.

FIG. 17 is a sectional view of the beam shaping unit shown in FIG. 16.

### DESCRIPTION OF THE EMBODIMENTS

Hereinafter, selected embodiments for implementing this disclosure will be described in detail with reference to the accompanying drawings. In the subsequent description, each drawing merely illustrates shape, size, positional relationship, and so on, schematically to the extent that enables the content of this disclosure to be understood; thus, this disclosure is not limited to the shape, the size, the positional relationship, and so on, illustrated in each drawing. In order to show the configuration clearly, part of hatching along a section is omitted in the drawings. Further, numerical values indicated herein are merely preferred examples of this disclosure; thus, this disclosure is not limited to the indicated numerical values.

### First Embodiment

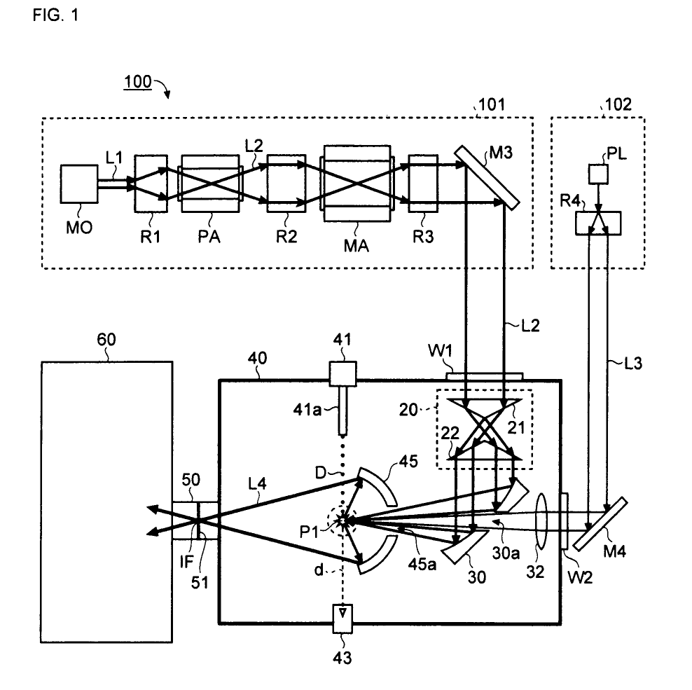

A first embodiment of this disclosure will be described in detail with reference to the drawings. FIG. 1 schematically shows an EUV light generation apparatus according to the first embodiment. An EUV light generation apparatus 100 may include a driver laser 101, a pre-pulse laser 102, and a chamber 40.

### Pre-Pulse Laser

The pre-pulse laser 102 may include a pre-pulse laser beam source PL and a relay optical system R4. The pre-pulse laser beam source PL may be configured to output a pulsed laser beam, as a pre-pulse laser beam L3, with which a target material (droplet D) supplied into the later-described chamber 40 may be irradiated. A semiconductor laser, such as a quantum cascade laser or a distributed feedback semiconductor laser, may be used for the pre-pulse laser beam source PL, for example. However, without being limited thereto, various lasers such as a solid-state laser may also be used. The pre-pulse laser beam L3 outputted from the pre-pulse laser beam source PL may then have the beam diameter thereof expanded by the relay optical system R4, and thereafter be outputted from the pre-pulse laser 102.

### Driver Laser

The driver laser 101 may include a master oscillator MO, relay optical systems R1 through R3, a preamplifier PA, a main amplifier MA, and a high-reflection mirror M3.

The master oscillator MO may be configured to output a pulsed laser beam as a seed beam L1. A semiconductor laser, such as a quantum cascade laser or a distributed feedback semiconductor laser, may be used for the master oscillator MO, for example. However, without being limited thereto, various lasers such as a solid-state laser may also be used.

The se ed beam L1 outputted from the master oscillator MO may then have the beam diameter thereof expanded by the relay optical system R1 and thereafter enter the preamplifier PA. The preamplifier PA may, for example, be a laser amplifier containing a CO₂ gas as a gain medium. The relay optical system R1 may be configured to expand the beam diameter of the seed beam L1 such that the seed beam L1 may pass through an amplification region of the preamplifier PA efficiently. The preamplifier PA may be configured to amplify, of the seed beam L1 having entered thereinto, a laser beam at a wavelength contained in at least one gain bandwidth specific to the gain medium thereinside, and may output the amplified laser beam as a main pulse laser beam L2.

The main pulse laser beam L2 outputted from the master oscillator MO may then have the beam diameter thereof expanded and be collimated by the relay optical system R2, and may enter the main amplifier MA. As in the preamplifier PA, the main amplifier MA may, for example, be a laser amplifier containing a CO₂ gas as a gain medium. The relay optical system R2 may be configured to expand the beam diameter of the main pulse laser beam L2 such that the main pulse laser beam L2 may pass through an amplification region of the main amplifier MA efficiently. As in the preamplifier PA, the main amplifier MA may be configured to amplify, of the laser beam L2 having entered thereinto, a laser beam at a wavelength contained in at least one gain bandwidth specific to the gain medium thereinside. The main pulse laser beam L2 may be amplified more efficiently when the gain bandwidth of the main amplifier MA coincides with the gain bandwidth of the preamplifier PA. That is, when the same gain medium (CO₂ gas, for example) is used as the gain medium in both the preamplifier PA and the main amplifier MA, the main pulse laser beam L2 may be amplified more efficiently.

The main pul se laser beam L2 outputted from the main amplifier MA may be collimated by the relay optical system R3, reflected by the high-reflection mirror M3, and thereafter outputted from the driver laser 101. The relay optical system R3 and the high-reflection mirror M3 may not necessarily be included in the driver laser 101.

### Chamber

The main pulse laser beam L2 outputted from the drier laser 101 may enter the chamber 40 via a window W1. The pre-pulse laser beam L3 outputted from the pre-pulse laser 102 may enter the chamber 40 via a window W2. The chamber 40 may be provided with a beam shaping unit 20, an off-axis paraboloidal mirror 30, and a focusing lens 32. The chamber 40 may further be provided with a droplet generator 41, a droplet collection unit 43, and an EUV collector mirror 45.

### Window

A transparent substrate, such as a diamond substrate, which excels in thermal stability and has a high transmission factor for the main pulse laser beam L2 and the pre-pulse laser beam L3, may preferably be used for the windows WI and W2. The respective windows W1 and W2 may preferably be inclined 3 to 5 degrees with respect to beam axes of the laser beams incident thereon so that laser beams reflected at the surfaces of the respective windows W1 and W2 may not form a hot-spot on a surface of an optical element in optical systems, such as the relay optical systems R3 and R4, disposed upstream of the windows W1 and W2. Further, the windows WI and W2 may respectively be provided with antireflection coatings corresponding to the respective wavelengths of the main pulse laser beam L2 and the pre-pulse laser beam L3.

### Beam Shaping Unit

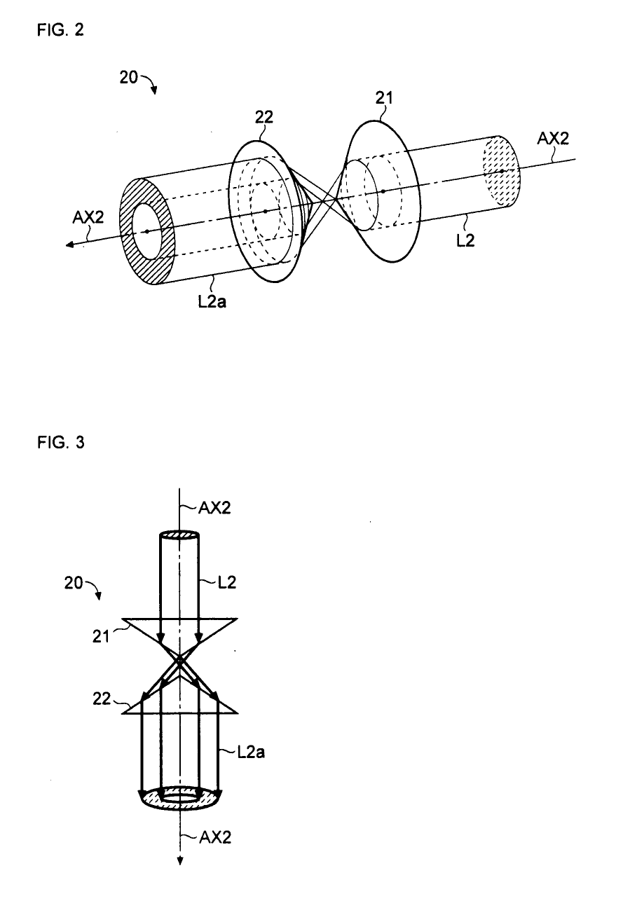

The main pul se laser beam L2 having entered the chamber 40 via the window W1 may be transformed into a hollow main pulse laser beam L2a, of which the cross-section is annular in shape, by the beam shaping unit 20. FIGS. 2 and 3 show an example of the beam shaping unit according to the first embodiment. FIG. 3 is a sectional view of the beam shaping unit shown in FIG. 2. As shown in FIG. 2, the beam shaping unit 20 may include two axicon lenses 21 and 22. As shown in FIG. 3, the axicon lenses 21 and 22 may be disposed such that the vertices thereof face each other with a predetermined gap therebetween. Further, the axicon lenses 21 and 22 may preferably disposed such that extensions of the respective optical axes thereof substantially coincide with each other. With the beam shaping unit 20 configured as described above, when the main pulse laser beam L2, of which the cross section is circular in shape, is incident, for example, on the bottom surface of the axicon lens 21, the hollow main pulse laser beam L2a, of which the cross section is annular in shape, may be outputted from the bottom surface of the axicon lens 22. At this time, controlling the distance between the respective vertices of the axicon lenses 21 and 22 may make it possible to control the inner and outer diameters of the hollow main pulse laser beam L2a. Here, the main pulse laser beam L2 may preferably be incident on the bottom surface of the axicon lens 21 perpendicularly. Further, the main pulse laser beam L2 may preferably be incident on the axicon lenses 21 and 22 such that the beam axis thereof substantially coincides with the respective optical axes of the axicon lenses 21 and 22.

### Off-Axis Paraboloidal Mirror

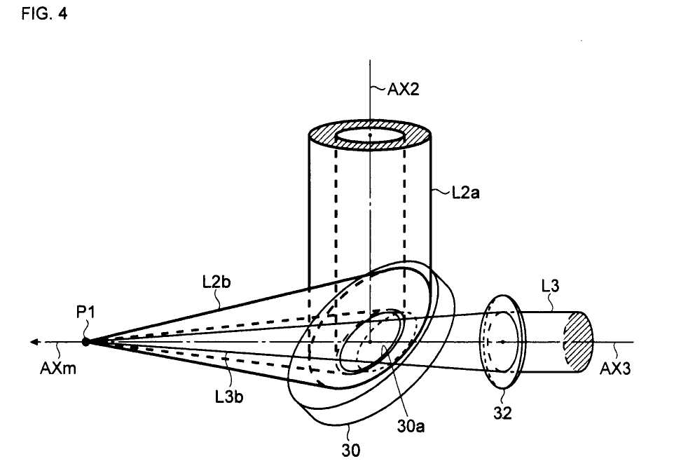

The hollow main pulse laser beam L2a may be incident on the off-axis paraboloidal mirror 30 of a focusing optical system. FIG. 4 shows an example of the focusing optical system including the off-axis paraboloidal mirror and the focusing lens. The off-axis paraboloidal mirror 30 may be provided with a through-hole 30a at substantially the center thereof. The hollow main pulse laser beam L2a may be reflected by the reflective surface of the off-axis paraboloidal mirror 30 to thereby be focused in the plasma generation region P1 inside the chamber 40. Here, the inner diameter of the hollow main pulse laser beam L2a may preferably substantially coincide with the diameter of the through-hole 30a in the off-axis paraboloidal mirror 30. The hollow main pulse laser beam L2a reflected by the off-axis paraboloidal mirror 30 may be transformed into a conical hollow main pulse laser beam L2b.

### Focusing Lens

The pre-pulse laser beam L3 outputted from the pre-pulse laser 102 (See FIG. 1) may be reflected by a high-reflection mirror M4 and thereafter be incident on the focusing lens 32 (See FIG. 4) inside the chamber 40 via the window W2. The focusing lens 32 may output the pre-pulse laser beam L3 incident thereon as a pre-pulse laser beam L3b to be focused in the plasma generation region P1. The pre-pulse laser beam L3b may be focused on the plasma generation region P1 via the through-hole 30a. That is, the pre-pulse laser beam L3b and the conical hollow main pulse laser beam L2b may travel in the same direction toward the plasma generation region P1 and be focused thereon. Here, the focusing lens 32 may preferably be disposed such that an optical axis AX3 thereof corresponds to the extension of the beam axis of the conical hollow main pulse laser beam L2b reflected by the off-axis paraboloidal mirror 30. Note that the foci of the conical hollow main pulse laser beam L2b and the pre-pulse laser beam L3b may not coincide with each other.

### Droplet Generator

Referring again to FIG. 1, the droplet generator 41 may be configured to supply the target material (such as Sn) to be turned into plasma in the plasma generation region P1. The droplet generator 41 may be configured to supply the target material in the form of the droplet D. More specifically, the droplet generator 41 may be configured such that Sn serving as the target material is stored thereinside in a molten state and molten Sn is outputted in the form of the droplet D toward the plasma generation region P1 through a nozzle 41a.

### Pre-Plasma and Target Fragment Group

The dropl et D arriving at the plasma generation region P1 may be irradiated with the pre-pulse laser beam L3b. The droplet D, having been irradiated with the pre-pulse laser beam L3b, may be transformed into a fluid target. In this application, the fluid target may be defined as a state of a target containing at least one of pre-plasma and a fragment group. The pre-plasma may refer to a plasma state or a state in which ions, electrons, and atoms of the target material are mixed and coexist therein. The fragment group may refer to a particulate group containing fine particulates such as clusters and micro-droplets of the target material scattered by being irradiated with the laser beam, or to a fine particulate group in which the fine particulates are mixed and coexist.

### EUV Collector Mirror

The fluid target may be irradiated with the conical hollow main pulse laser beam L2b. With this, the fluid target may be turned into plasma. Light containing EUV light L4 at a desired wavelength (13.5 nm, for example) may be emitted from the plasma. A part of the emitted light may be incident on the EUV collector mirror 45. The EUV collector mirror 45 may, of the light incident thereon, selectively reflect at least the EUV light L4 at the desired wavelength. The EUV collector mirror 45 may be configured to focus the EUV light L4 selectively reflected thereby on a predetermined site (intermediate focus IF, for example).

The EUV collector mirror 45 may preferably be provided with a through-hole 45a at substantially the center thereof. The pre-pulse laser beam L3b and the conical hollow main pulse laser beam L2b may be focused on the plasma generation region P1 via the through-hole 45a. Accordingly, the pre-pulse laser beam L3b and the conical hollow main pulse laser beam L2b may travel in the same direction from the side of the EUV collector mirror 45 toward the plasma generation region P1 and be focused thereon.

### Exposure Apparatus Connection and Exposure Apparatus

The interm ediate focus IF may be set inside an exposure apparatus connection 50 configured to connect the chamber 40 to an exposure apparatus 60. The exposure apparatus connection 50 may be provided with a partition wall 51 with a pinhole formed therein. The EUV light L4 focused on the intermediate focus IF may travel through the pinhole and then be propagated to the exposure apparatus 60 via an optical system (not shown).

### Droplet Collection Unit

A droplet D which is not irradiated with the pre-pulse laser beam L3b or the conical hollow main pulse laser beam L2b in the plasma generation region P1, or a target material which has been irradiated with the laser beam but has not been turned into plasma may be collected by the droplet collection unit 43, for example. The droplet collection unit 43 may be disposed along a direction through which the droplet D may travel.

As described above, according to the first embodiment, the pre-pulse laser beam L3b and the conical hollow main pulse laser beam L2b may strike the target material in substantially the same direction. It may be possible to have a pre-pulse laser beam and a main pulse laser beam strike a target material in the same direction with a configuration in which, for example, a beam combiner is used to make the beam paths of the laser beams coincide with each other. However, with the configuration in which the beam combiner is used, it may be necessary to coat a substrate for the beam combiner with a coating corresponding to both the wavelengths of the pre-pulse laser beam and of the main pulse laser beam. Such a coating may, in some cases, largely attenuate the energy of the laser beams when the laser beams are reflected thereby or transmitted therethrough. According to the first embodiment, however, the optical elements on the beam path of the pre-pulse laser beam and the optical elements on the beam path of the main pulse laser beam may be separated spatially. Accordingly, the optical elements disposed on the respective beam paths of the laser beams may be configured to suit with the respective laser beams. Thus, compared to the configuration in which the beam combiner is used, the laser beams (see FIG. 1) may be allowed to travel to the plasma generation region P1 with lesser energy loss. Accordingly, the conical hollow main pulse laser beam L2b may be absorbed by the target material more efficiently. Further, irradiating the target material with the pre-pulse laser beam L3b and the conical hollow main pulse laser beam L2b from the side of the EUV collector mirror 45 can improve collection efficiency of the EUV light L4.

In addition, according to the first embodiment, the main pulse laser beam L2 may be transformed into the hollow main pulse laser beam L2a. Here, the inner diameter of the hollow main pulse laser beam L2a may coincide with the diameter of the through-hole 30 provided in the off-axis paraboloidal mirror 30, and the hollow main pulse laser beam L2a may be incident on the off-axis paraboloidal mirror 30. With this, a part of the hollow main pulse laser beam L2a, which is not reflected by the off-axis paraboloidal mirror 30 and passes through the through-hole 30a, may be reduced.

### Second Embodiment

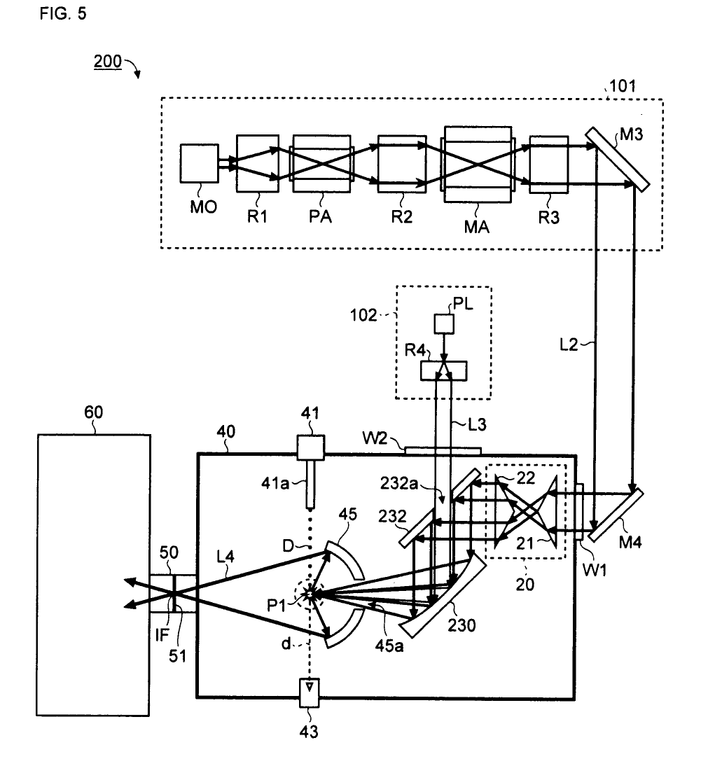

A second embodiment of this disclosure will be described in detail with reference to the drawings. FIG. 5 schematically shows an EUV light generation apparatus according to the second embodiment. In the description to follow, configurations similar to those of the first embodiment are referenced by similar referential symbols and duplicate description thereof will be omitted.

As it may be apparent when FIGS. 1 and 5 are compared, an EUV light generation apparatus 200 (FIG. 5) may be similar in configuration to the EUV light generation apparatus 100 (FIG. 1). However, in the second embodiment, the off-axis paraboloidal mirror 30 may be replaced by an off-axis paraboloidal mirror 230, the focusing lens 32 may be omitted, and a flat mirror 232 may be added. In the second embodiment, the directions in which the main pulse laser beam L2 and the pre-pulse laser beam L3 travel into the chamber 40 may be switched, but this disclosure is not limited thereto.

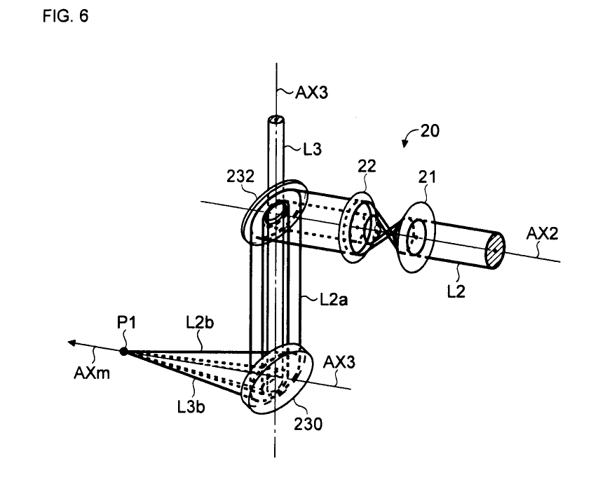

FIG. 6 schematically shows the beam shaping unit 20, the flat mirror 232, and the off-axis paraboloidal mirror 230, shown in FIG. 5. As shown in FIGS. 5 and 6, the flat mirror 232 may be provided with a through-hole 232a at substantially the center thereof. The pre-pulse laser beam L3 having entered the chamber 40 via the window W2 may travel through the through-hole 232a and be incident on the off-axis paraboloidal mirror 230. The pre-pulse laser beam L3 may be reflected by the reflective surface of the off-axis paraboloidal mirror 230 to thereby be focused on the plasma generation region P1 inside the chamber 40. The main pulse laser beam L2 having entered the chamber 40 via the window W1 may be transformed into the hollow main pulse laser beam L2a by the beam shaping unit 20 and thereafter be incident on the flat mirror 232. Here, the inner diameter of the hollow main pulse laser beam L2a may substantially coincide with the diameter of the through-hole 232a in the flat mirror 232. With this, the hollow main pulse laser beam L2a may be reflected by the flat mirror 232 with the cross section thereof being maintained annular in shape. Subsequently, the hollow main pulse laser beam L2a may be incident on the off-axis paraboloidal mirror 230. The hollow main pulse laser beam L2a may be reflected by the reflective surface of the off-axis paraboloidal mirror 230 to thereby be transformed into the conical hollow main pulse laser beam L2b, and be focused in the plasma generation region P I inside the chamber 40.

As described above, the configuration in which the flat mirror 232 having the through-hole 232a provided at substantially the center thereof is used may also allow the pre-pulse laser beam L3 and the conical hollow main pulse laser beam L2b to strike the target material in substantially the same direction. With this, the conical hollow main pulse laser beam L2b may be absorbed more efficiently by the target material. Further, the man pulse laser beam L2 may be transformed into the hollow main pulse laser beam L2a prior to being incident on the flat mirror 230. Here, the inner diameter of the hollow main pulse laser beam L2a may coincide with the diameter of the through-hole 232a provided in the flat mirror 232. With this, a part of the hollow main pulse laser beam L2a, which is not reflected by the flat mirror 232 and passes through the through-hole 232a, may be reduced. Other configurations and effects may be similar to those of the above-described first embodiment, and thus duplicate description thereof will be omitted.

### Third Embodiment

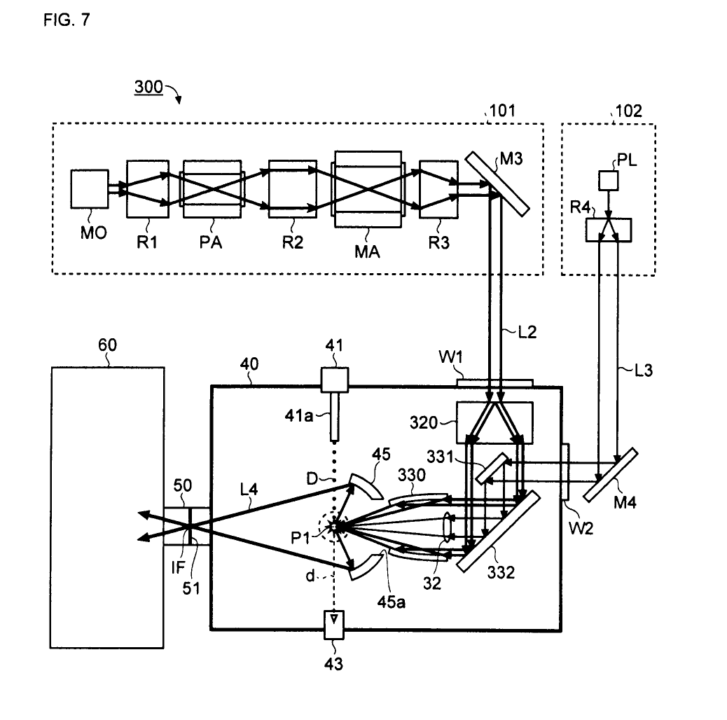

A third embodiment of this disclosure will be described in detail with reference to the drawings. FIG. 7 schematically shows the configuration of an EUV light generation apparatus according to the third embodiment. In the description to follow, configurations similar to those of the first or second embodiment are referenced by similar referential symbols and duplicate description thereof will be omitted.

As it may be apparent when FIGS. 1 and 7 are compared, an EUV light generation apparatus (FIG. 7) may be similar in configuration to the EUV light generation apparatus 100 (FIG. 1). However, in the third embodiment, the beam shaping unit 20 may be replaced by a beam shaping unit 320, the off-axis paraboloidal mirror 30 may be replaced by a rotationally symmetric off-axis paraboloidal mirror 330, and high-reflection flat mirrors 331 and 332 may be added.

The main pulse laser beam L2 having entered the chamber 40 via the window W1 may first be transformed into the hollow main pulse laser beam L2a by the beam shaping unit 320 and thereafter be reflected by the high-reflection flat mirror 332. The pre-pulse laser beam L3 having entered the chamber 40 via the window W2 may be reflected by the high-reflection flat mirror 331. The high-reflection flat mirror 331 may preferably be disposed on the beam path of the hollow main pulse laser beam L2a so as not to block the hollow main pulse laser beam L2a. The high-reflection flat mirror 331 may preferably be disposed so as to be positioned within the hollow part of the hollow main pulse laser beam L2a. Further, the high-reflection flat mirror 331 may preferably be disposed such that the beam axis of the pre-pulse laser beam L3 reflected thereby substantially coincides with the beam axis of the hollow main pulse laser beam L2a outputted from the beam shaping unit 320. This configuration may allow the beam axes of the pre-pulse laser beam L3 and the hollow main pulse laser beam L2a outputted from the beam shaping unit 320 to substantially coincide with each other. The pre-pulse laser beam L3 reflected by the high-reflection flat mirror 331 may be reflected by the high-reflection flat mirror 332 toward the same direction as the hollow main pulse laser beam L2a.

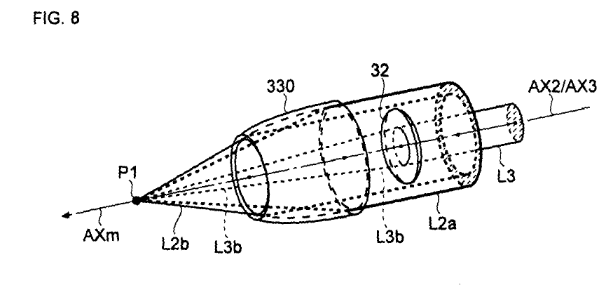

The hollow main pulse laser beam L2a reflected by the high-reflection flat mirror 332 may then be reflected by the rotationally symmetric off-axis paraboloidal mirror 330. FIG. 8 shows an example of the rotationally symmetric off-axis paraboloidal mirror and the focusing lens. As shown in FIG. 8, the rotationally symmetric off-axis paraboloidal mirror 330 may be generally cylindrical in shape with the inner surface thereof, serving as the reflective surface, being a rotationally symmetric off-axis paraboloidal in shape. The hollow main pulse laser beam L2a may be reflected by the rotationally symmetric off-axis paraboloidal mirror 330 to thereby be transformed into the conical hollow main pulse laser beam L2b, and be focused on the plasma generation region P1 inside the chamber 40.

The pr e-pulse laser beam L3 reflected by the high-reflection flat mirror 332 may be transformed into the pre-pulse laser beam L3b by the focusing lens 32 (See FIG. 8), and be focused in the plasma generation region P1 inside the chamber 40. The focusing lens 32 may preferably be disposed on the beam path of the conical hollow main pulse laser beam L2b so as not to block the conical hollow main pulse laser beam L2b. The focusing lens 32 and the rotationally symmetric off-axis paraboloidal mirror 330 may preferably be disposed such that the optical axis of the focusing lens 32 may substantially coincide with the axis of symmetry of the rotationally symmetric off-axis paraboloidal mirror 330.

As described above, the configuration in which the high-reflection flat mirror 331 is disposed within the hollow part of the hollow main pulse laser beam L2a may also allow the pre-pulse laser beam L3 and the conical hollow main pulse laser beam L2b to strike the target material in substantially the same direction, and thus the conical hollow main pulse laser beam L2b may be absorbed more efficiently by the target material. Other configurations and effects may be similar to those of the above-described first or second embodiment, and thus duplicate description thereof will be omitted.

### Fourth Embodiment

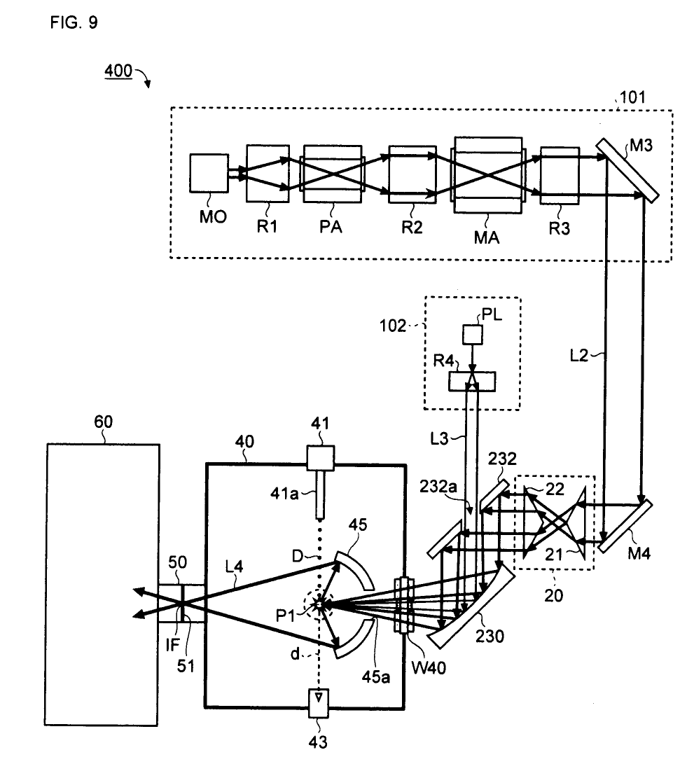

A fourth embodiment of this disclosure will be described in detail with reference to the drawings. FIG. 9 schematically shows the configuration of an EUV light generation apparatus according to the fourth embodiment. In the description to follow, configurations similar to those of any of the first through third embodiments are referenced by similar referential symbols and duplicate description thereof will be omitted.

As it may be apparent when FIGS. 5 and 9 are compared, an EUV light generation apparatus 400 (FIG. 9) may be configured such that the beam shaping unit 20, the flat mirror 232, and the off-axis paraboloidal mirror 232 of the EUV light generation apparatus 200 (FIG. 5) are disposed outside the chamber 40. Further, in the EUV light generation apparatus 400, the windows W1 and W2 may be replaced by a window W40.

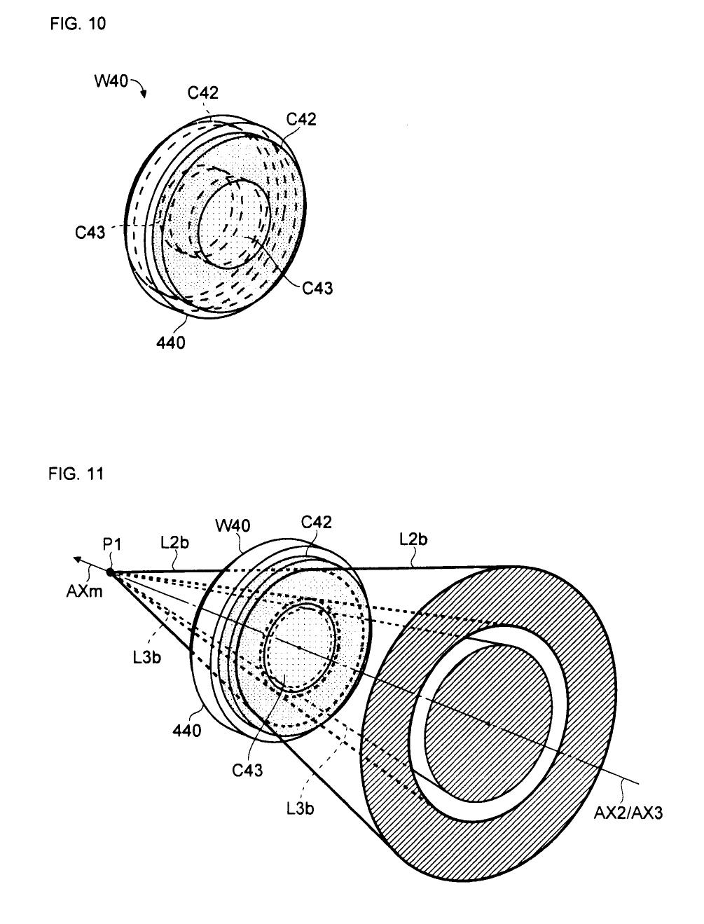

The pre-pulse laser beam L3 and the hollow main pulse laser beam L2a reflected respectively by the off-axis paraboloidal mirror 230 may travel through the window 40 and be focused on the plasma generation region P1. FIG. 10 schematically shows the configuration of the window W40. FIG. 11 shows an example of the conical hollow main pulse laser beam L2b and the pre-pulse laser beam L3b traveling through the window 40. The window 40 may include a window substrate 440, such as a diamond substrate, for example. The window substrate 440 may be provided, at substantially the center of the flat surfaces thereof, with anti-reflection coatings C43 for improving the transmittance of the pre-pulse laser beam L3b. The window substrate 440 may also be provided with anti-reflection coatings C42 for improving the transmittance of the conical hollow main pulse laser beam L2b, the anti-reflection coating C42 being provided so as to surround the anti-reflection coating C43.

As described above, the configuration in which the beam shaping unit 20, the flat mirror 232, and the off-axis paraboloidal mirror 230 are disposed outside the chamber 40 may allow debris generated when the target material is irradiated with the laser beam from adhering to the above optical elements. However, not all of the beam shaping unit 20, the flat mirror 233, and the off-axis paraboloidal mirror 230 need to be disposed outside the chamber 40. Further, although the fourth embodiment herein may be based on the second embodiment, without being limited thereto, the fourth embodiment may be applied to any of the first through third embodiments. Other configurations and effects may be similar to those of any of the above-described first through third embodiments, and thus duplicate description thereof will be omitted.

### First Modification of Beam Shaping Unit

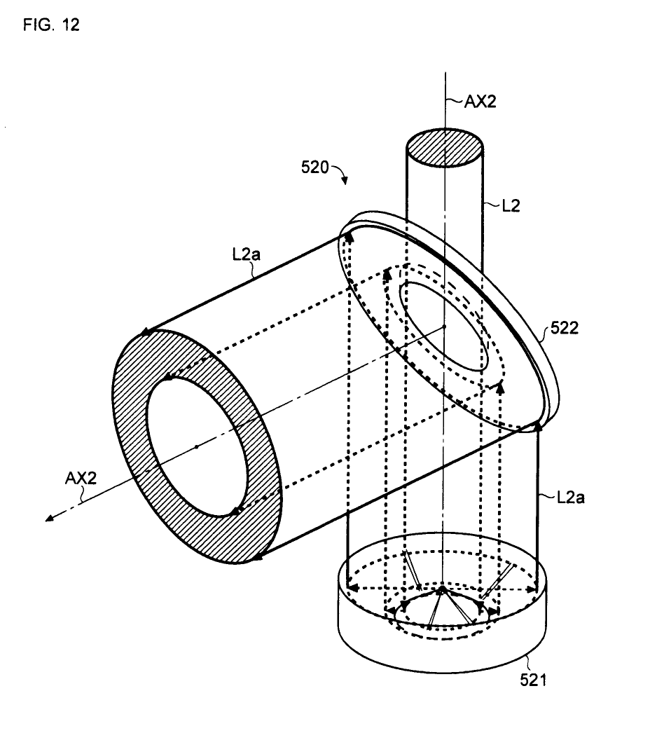

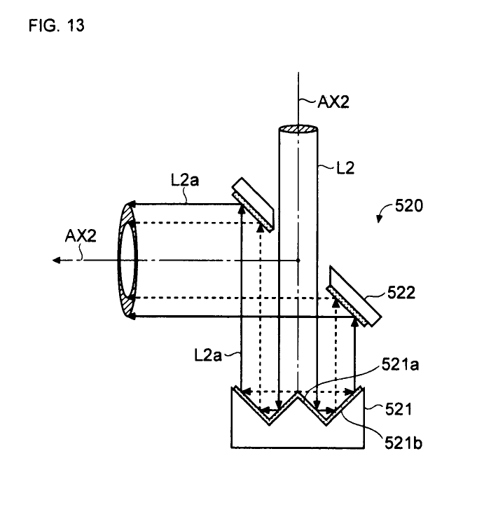

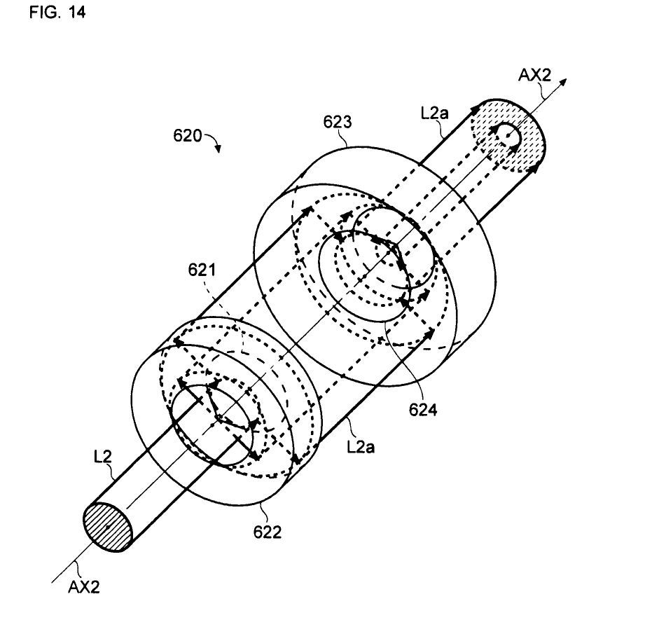

A first modification of the above-described beam shaping unit will be described. FIG. 12 shows a beam shaping unit according to the first modification. FIG. 13 is a cross-sectional view of the beam shaping unit shown in FIG. 12. As shown in FIGS. 12 and 13, a beam shaping unit 520 may include a W-axicon mirror 521 and a flat mirror 522. The W-axicon mirror 521 may be a coaxial mirror including a conical convex part 521 a and a truncated-conical side part 521b disposed coaxially, the truncated conical side part 521b surrounding the conical convex part 521a. The flat mirror 522 may preferably be provided with a through-hole at substantially the center thereof. The W-axicon mirror 521 and the flat mirror 522 may be coated, at the respective reflective surfaces thereof, with reflective films for improving the reflectance of the main pulse laser beam L2. The main pulse laser beam L2 may be incident on the conical convex part 521 a of the W-axicon mirror 521 and be reflected toward the truncated-conical side part 521b. Then, the main pulse laser beam L2 may be reflected by the truncated-conical side part 521b of the W-axicon mirror 521 and be transformed into the hollow main pulse laser beam L2a. In this way, configuring the beam shaping unit 520 with reflective optical elements may make it possible to generate the hollow main pulse laser beam L2a while suppressing thermal deformation in the optical elements.

### Second Modification of Beam Shaping Unit

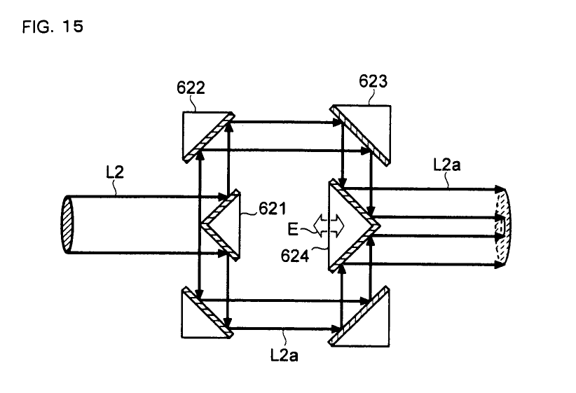

The above-described beam shaping unit may be modified as shown in FIGS. 14 and 15. As shown in FIGS. 14 and 15, a beam shaping unit 620 according to a second modification may include four axicon mirrors 621 through 624. The axicon mirrors 621 and 624 may have conically-shaped reflective surfaces, respectively, and the axicon mirrors 622 and 623 may be annular in shape and may have tapered reflective surfaces, respectively, at the inner circumferential sides thereof. Each reflective surface may be coated with a reflective film for improving the reflectance of the main pulse laser beam L2. The axicon mirrors 621 and 622 may preferably be disposed such that the respective reflective surfaces thereof face each other. The axicon mirrors 623 and 624 may preferably be disposed such that the respective reflective surfaces thereof face each other. Further, the axicon mirrors 621 and 622 may preferably be disposed such that the respective reflective surfaces thereof are substantially parallel with each other. Similarly, the axicon mirror 623 and 624 may preferably be disposed such that the respective reflective surfaces thereof are substantially parallel with each other. In this configuration, the main pulse laser beam L2 may be incident on the axicon mirror 621, be reflected by the mirror 621 toward the axicon mirror 622, and be transformed into the hollow main pulse laser beam L2a by the mirror 622. Then, the hollow main pulse laser beam L2a may have the diameter thereof be adjusted by the axicon mirrors 623 and 624. More specifically, moving the axicon mirror 624 in the direction shown with the arrow E in FIG. 15 with respect to the axicon mirror 623 may allow the diameter of the cross section of the hollow main pulse laser beam L2a outputted from the beam shaping unit 620 to be adjusted. In the second modification, as in the first modification, the beam shaping unit 620 may include reflective optical elements, which may make it possible to generate the hollow main pulse laser beam L2a while suppressing thermal deformation in the optical elements.

### Third Modification of Beam Shaping Unit

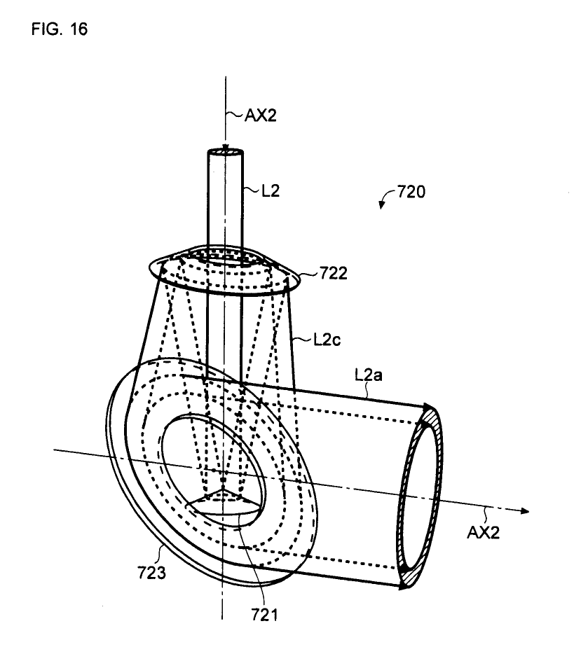

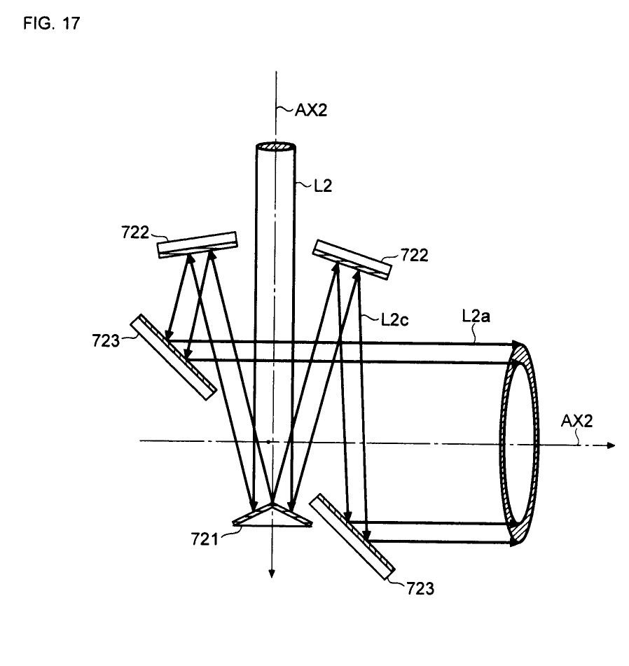

The above-described beam shaping unit may be modified as shown in FIGS. 16 and 17. As shown in FIGS. 16 and 17, a beam shaping unit 720 according to a third modification may include two axicon mirrors 721 and 722 and a flat mirror 723. The axicon mirror 721 may have a conically-shaped reflective surface. The axicon mirror 722 may be annular in shape and may have the tapered inner circumferential surface. The flat mirror 723 may be annular in shape. Each reflective surface may be coated with a reflective film for improving the reflectance of the main pulse laser beam L2.

In this configuration, the main pulse laser beam L2 may be incident on the axicon mirror 721, and be reflected by the axicon mirrors 721 and 722, to thereby be transformed into a hollow main pulse laser beam L2c. Then, the hollow main pulse laser beam L2c may be reflected by the flat mirror 723 to thereby be transformed into the hollow main pulse laser beam L2a. More specifically, the main pulse laser beam L2 may travel through an annular through-hole in the axicon mirror 722 and be incident on the axicon mirror 721. The main pulse laser beam L2 incident on the axicon mirror 721 may be reflected by the mirror to be transformed into the annular main pulse laser beam L2c, which then may be incident on the inner circumferential surface of the axicon mirror 722. The hollow main pulse laser beam L2c may be reflected by the axicon mirror 722 and be incident on the flat mirror 723 to thereby have the diameter thereof be expanded. The hollow main pulse laser beam L2c, having been reflected by the flat mirror 723, may be transformed into the hollow main pulse laser beam L2a. In the third modification, as in the first and second modifications, the beam shaping unit 720 may include reflective optical elements, which may make it possible to generate the hollow main pulse laser beam L2a while suppressing thermal deformation in the optical elements.

In the above-described embodiments and the modifications thereof, the main pulse laser beam L2 may be transformed into a hollow laser beam. However, without being limited thereto, the pre-pulse laser beam L3 may be transformed into a hollow laser beam. Further, in the above-described embodiments and the modifications thereof, a laser beam may be transformed into a hollow laser beam having an annular cross section. However, without being limited thereto, various modifications may be made, and for example, a laser beam may be transformed into a hollow laser beam having a rectangular cross section. That is, it may be sufficient as long as the beam shaping unit is configured to transform a laser beam incident thereon into a hollow laser beam. Alternatively, the beam shaping unit may be configured to transform a laser beam incident thereon into a laser beam having an arc-shaped cross section. The off-axis paraboloidal mirror may be sectoral in shape. The rotationally symmetric off-axis paraboloidal mirror may not need to be cylindrical in shape.

The above-described embodiments and the modifications thereof are merely examples for implementing this disclosure, and this disclosure is not limited thereto. Making various modifications according to the specifications or the like is within the scope of this disclosure, and it is apparent from the above description that other various embodiments are possible within the scope of this disclosure. For example, it is needless to state that the modifications illustrated for each of the embodiments can be applied to other embodiments as well.

The terms used in this specification and the appended claims should be interpreted as “non-limiting.” For example, the terms “include” and “be included” should be interpreted as “not limited to the stated elements.” The term “have” should be interpreted as “not limited to the stated elements.” Further, the modifier “one (a/an)” should be interpreted as “at least one” or “one or more.”

What is claimed is:

1. An apparatus for generating extreme ultraviolet light by using first and second laser beams from a laser apparatus, the apparatus comprising:
a chamber provided with at least one inlet through which at least one of the first and second laser beams outputted from the laser apparatus travels into the chamber;
a beam shaping unit, provided on a beam path of the first laser beam, for transforming the first laser beam into a hollow laser beam; and
a first focusing optical element, provided downstream of the beam shaping unit, for focusing the hollow laser beam on a first location inside the chamber.

2. The apparatus according to claim 1, further comprising a second focusing optical element, provided on a beam path of the second laser beam, for focusing the second laser beam on a second location inside the chamber.

3. The apparatus according to claim 2, wherein the first and second locations coincide with each other.

4. The apparatus according to claim 2, wherein
the at least one inlet includes first and second inlets through which the first and second laser beams respectively travel into the chamber,
the first focusing optical element is provided with a through-hole,
the first optical element is disposed between the second focusing optical element and the first location inside the chamber such that at least a part of the second laser beam outputted from the second focusing optical element travels through the through-hole in the first focusing optical element.

5. The apparatus according to claim 1, wherein the first focusing optical element is disposed so as to focus the second laser beam on a first predetermined position inside the chamber.

6. The apparatus according to claim 1, wherein the beam shaping unit includes a transmissive optical element.

7. The apparatus according to claim 1, wherein the beam shaping unit includes a reflective optical element.

8. The apparatus according to claim 2, wherein the first and second focusing optical elements include reflective optical elements, respectively.

9. The apparatus according to claim 1, wherein the beam shaping unit includes a reflective axicon optical element.

10. The apparatus according to claim 1, wherein the beam shaping unit includes a transmissive axicon optical element.

11. The apparatus according to claim 1, wherein the first focusing optical element is disposed so as to focus the second laser beam on a second predetermined location inside the chamber.
